(19) United States
(12) Patent Application Publication
(10) Pub. No.: US 2025/0293944 A1
(43) Pub. Date: Sep. 18, 2025

(54) METHODS, ARCHITECTURES, APPARATUSES AND SYSTEMS FOR DISTRIBUTED ARTIFICIAL INTELLIGENCE

(71) Applicant: InterDigital CE Patent Holdings, SAS, Paris (FR)

(72) Inventors: Stephane Onno, Saint Gregoire (FR); Cyril Quinquis, Melesse (FR); Thierry Filoche, Chateaugiron (FR)

(21) Appl. No.: 18/861,404

(22) PCT Filed: Apr. 24, 2023
(86) PCT No.: PCT/EP2023/060643

§ 371 Date: Oct. 29, 2024

(30) Foreign Application Priority Data
Apr. 29, 2022 (EP) 22305646.6
Nov. 8, 2022 (EP) 22290060.7

(51) Int. Cl. H04L 41/16; H04W 76/20; H04W 88/02

(52) U.S. Cl. CPC H04L 41/16; H04W 76/20; H04W 88/02

(57) ABSTRACT

Procedures, methods, architectures, apparatuses, systems, devices, and computer program products for distributed Artificial Intelligence, AI. A first device receives from a second device information indicative of a plurality of distributed Artificial Intelligence, AI, models, wherein each model of the plurality of distributed AI models corresponds to a same AI service, transmits, to the second device, a message including information indicative of a selected distributed AI model from among the plurality of distributed AI models, wherein the selected distributed AI model includes a plurality of model subsets making up the AI service, receives information corresponding to a model subset of the selected distributed AI model, and runs the model subset of the selected distributed AI model based on the information corresponding to the model subset.

### BACKGROUND

The present disclosure is generally directed to the fields of communications, software and encoding, including, for example, to methods, architectures, apparatuses, systems directed to collaborative Artificial Intelligence (AI).

### SUMMARY

In a first aspect, the present principles are directed to a method in which a first device receives from a second device information indicative of a plurality of distributed Artificial Intelligence, AI, models, wherein each model of the plurality of distributed AI models corresponds to a same AI service, transmits, to the second device, a message including information indicative of a selected distributed AI model from among the plurality of distributed AI models, wherein the selected distributed AI model includes a plurality of model subsets making up the AI service, receives information corresponding to a model subset of the selected distributed AI model, and runs the model subset of the selected distributed AI model based on the information corresponding to the model subset.

In a second aspect, the present principles are directed to a first device comprising memory storing processor-executable program instructions and at least one hardware processor configured to execute the program instructions to receive from a second device information indicative of a plurality of distributed Artificial Intelligence, AI, models, wherein each model of the plurality of distributed AI models corresponds to a same AI service, transmit, to the second device, a message including information indicative of a selected distributed AI model from among the plurality of distributed AI models, wherein the selected distributed AI model includes a plurality of model subsets making up the AI service, receive information corresponding to a model subset of the selected distributed AI model, and run the model subset of the selected distributed AI model based on the information corresponding to the model subset.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates different examples of splitting of an AI/ML model;

FIG. 3 illustrates examples of split topologies where the UE ingests sensing data and acts as an uplink data source;

FIG. 4 illustrates examples of split topologies where sensing data comes from a content Provider/Remote UE via the cloud/Edge Server acting as downlink data source;

FIGS. 5A and 5B together illustrate a flow chart for distributed AI/ML according to an embodiment;

FIG. 6 illustrates an example of split node configuration;

FIG. 7 illustrates a flow chart for split node configuration and session establishment according to an embodiment;

FIG. 8 illustrates a further example of split node configuration;

FIG. 9 illustrates a flow chart for split node configuration and session establishment according to a further embodiment;

FIGS. 10A and 10B together illustrate a flow chart for split node configuration and session establishment according to a further embodiment; and

FIG. 11 illustrates an example of data transport between AI/ML split devices.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

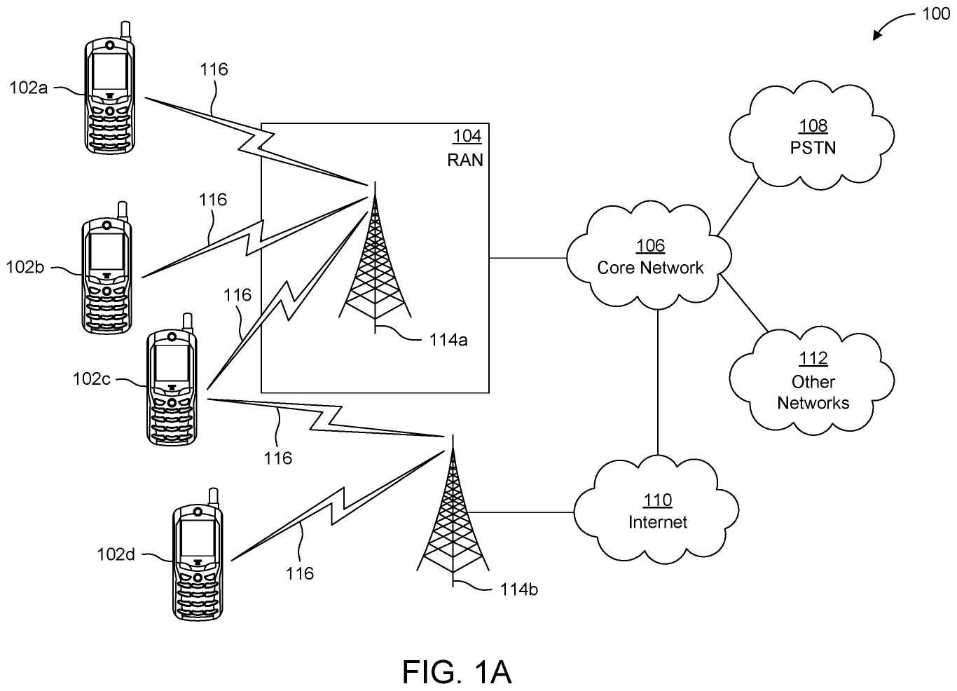

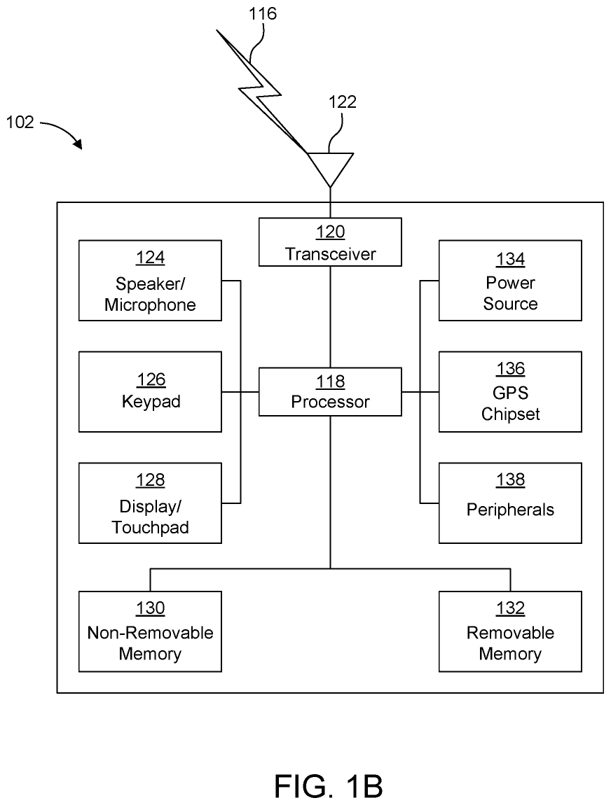

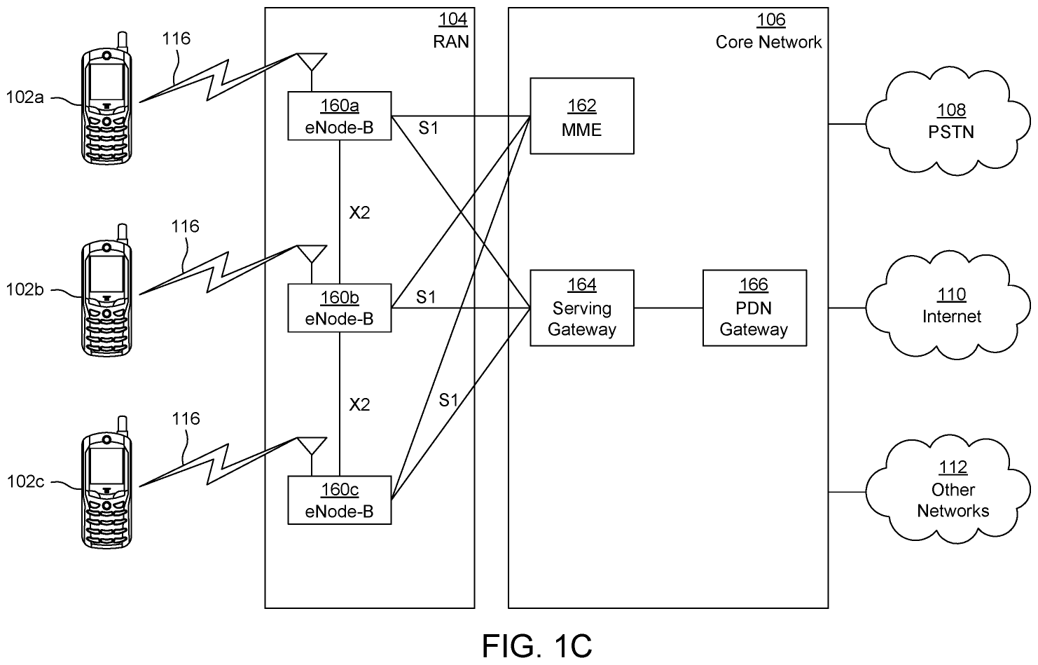

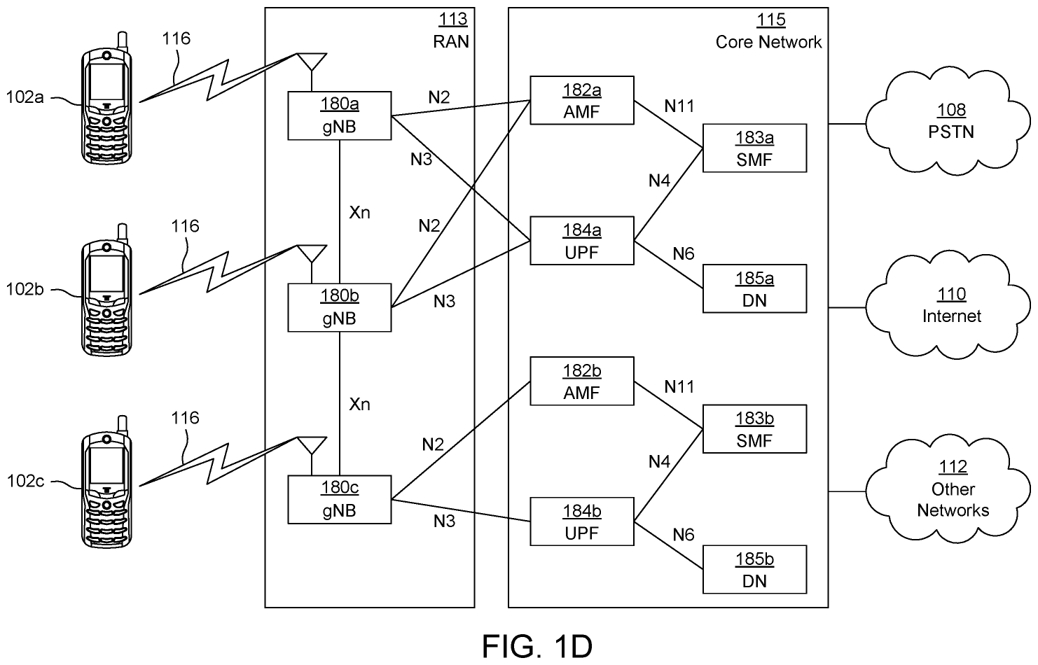

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102.

The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz.

The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

While Artificial Intelligence (AI), in particular Machine Learning (ML) can be a very powerful tool in various devices, it will be understood that the resource (e.g. processing) requirements can be too big for devices with relatively limited resources. Such devices, in this description denoted UEs, can be end user devices, in particular mobile devices such as smartphones and tablets. For this reason, it is a common solution to let one or more other devices perform at least part of the calculations. It is noted that ‘device’ (also called ‘node’) in this context may mean a plurality of devices acting as one, for example in the case of server banks and cloud computing.

AI/ML inference can thus be divided (i.e. split) over different points (e.g. from UEs to Edge or Cloud devices) for a certain AI/ML application that for example may be based on a Deep Neural Network (DNN). The AI/ML application may for example be split along the interface between two layers in a DNN, or between different parts where one (e.g. a part detecting facial features) can provide a result as input to a following part (e.g. using detected facial features to a person's mood). The corresponding AI/ML model, i.e. the computer program (e.g. trained, i.e. with proper parameters), can thus be split into several AI/ML model subsets to be run on different devices/servers. Each AI/ML model subset is a piece of independent software to run on a split node such as for example a UE, an Edge device, in the Cloud or in an Access Network.

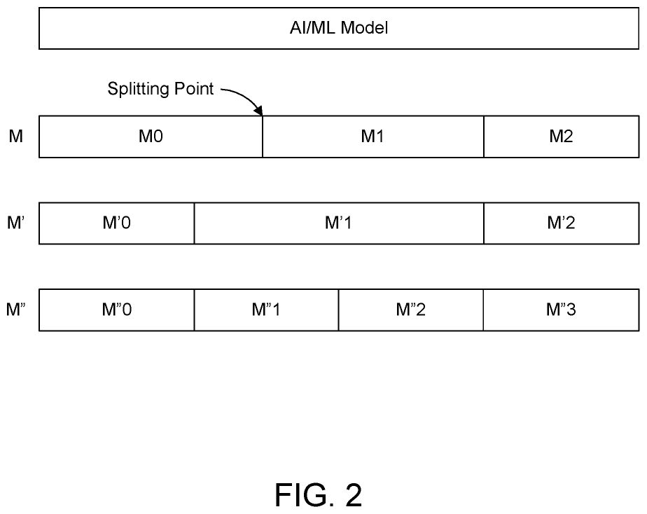

FIG. 2 illustrates different examples of splitting of an AI/ML model. An example AI/ML model can be split in different ways. For example, split model M can include AI/ML model subsets {M0, M1, M2}. Similarly for split model M′ can include {M′0, M′1, M′2} and split model M″ {M0″, M1″, M2″, M3″}. These three examples of split models M, M′, M″ provide the same service and, as can be seen, can be split into a different number of subsets. The border between different subsets will be referred to as a splitting point (split point, partition point), indicated by an illustrative arrow in one instance.

In addition, different subsets can run or be intended to be run on different devices. Which device a subset runs on can depend on different conditions. Example conditions include device capabilities, device load, and network load. A specific subset, say M0, can thus for example run either on an edge device or on the UE.

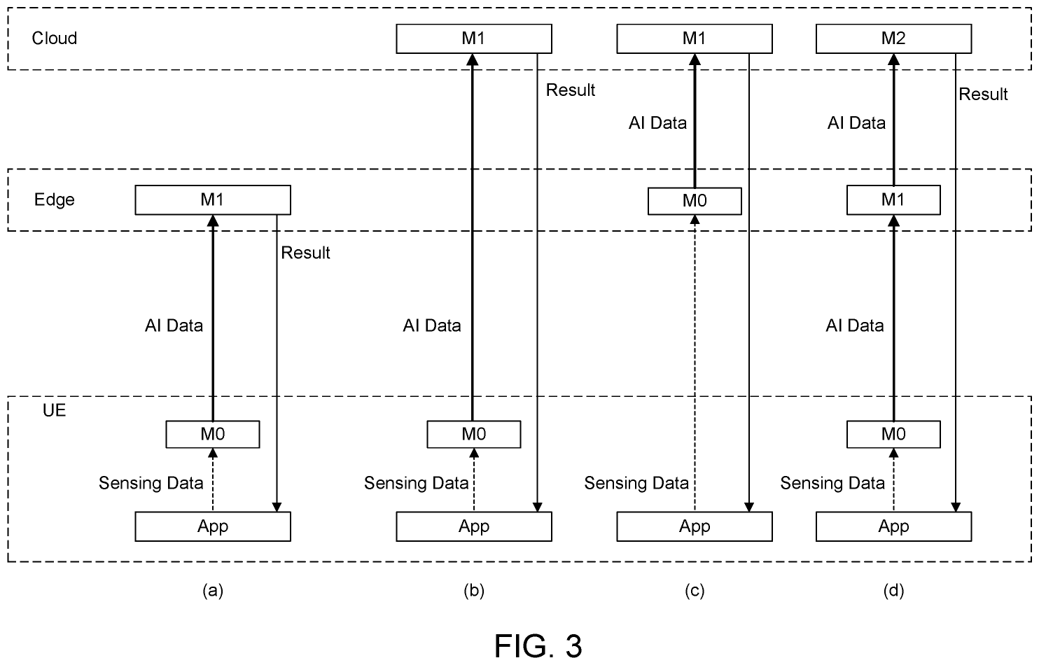

FIG. 3 illustrates examples of split topologies where the UE ingests sensing data and acts as an uplink data source.

It is assumed that the AI/ML model subsets have been obtained (e.g. downloaded, streamed) from a device such as a cloud or edge server node. The sensing data is provided by the UE (e.g. an application that captures video) to subset M0. In the examples, it is assumed that M0 processes the sensing data and outputs AI data to subset M1. M1 can process (i.e. infer) the AI data to obtain a result or forward different AI data to M2, which in turn processes the different AI data to obtain a result. The result is returned to the UE, possibly via the subset with an immediately lower number (e.g. M1 may provide the result via M0). The result can be provided to the application or be used directly by the UE.

In example (a), M0 resides on the UE and M1 resides on an edge device (node).

In example (b), M0 resides on the UE and M1 resides in the cloud.

In example (c), M0 resides on the edge device and M1 resides in the cloud.

In example (d), M0 resides on the UE, M1 resides on an edge device, and M2 in the cloud.

The result can be rendered in various ways, for example as a video or as a textual piece of information.

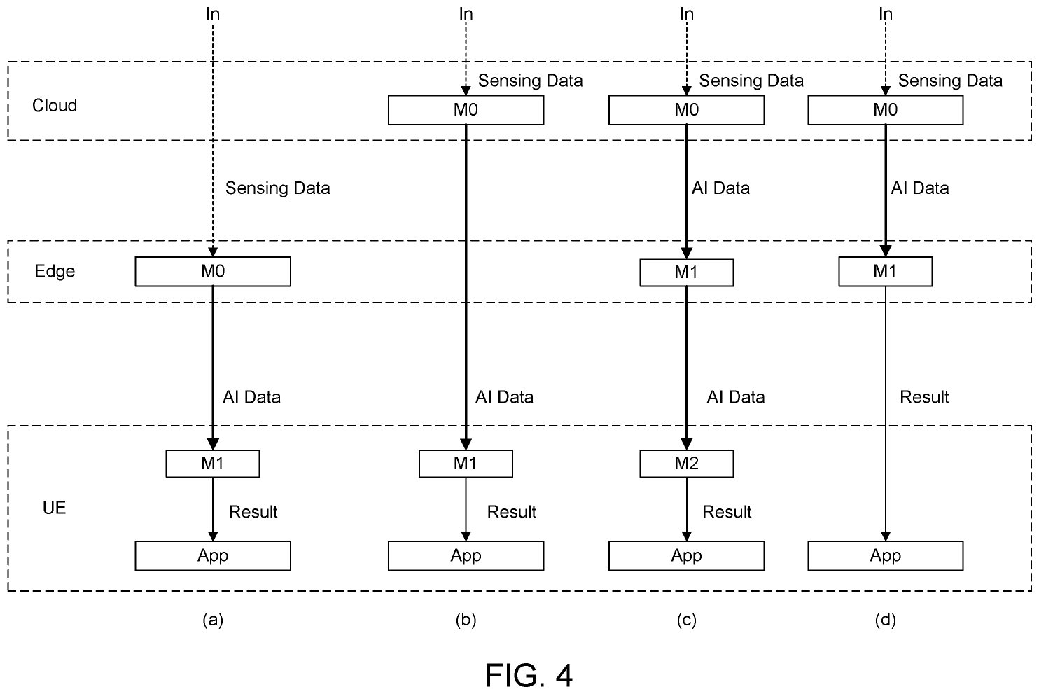

FIG. 4 illustrates examples of split topologies where sensing data comes from a content Provider/Remote UE via the cloud/Edge Server acting as downlink data source.

The AI/ML model subsets can be obtained as described with reference to FIG. 3.

The sensing data comes from a content provider device (not shown).

As in FIG. 3, the sensing data is processed (e.g. inferred) by M0 that then provides AI/ML data to the next subset M1 that obtains a result or provides AI data to the next subset M2, which in turn obtains the result.

It is noted that since the application on the UE is the intended target of the result, this is not returned as in FIG. 3. However, it is also noted that in case the result can be of interest to other devices, e.g. the source, it can still be returned like in FIG. 3.

The result can be rendered as in FIG. 3.

In example (a), M0 resides on an edge device (node) and M1 on the UE.

In example (b), M0 resides in the cloud and M1 on the UE.

In example (c), M0 resides in the cloud, M1 on an edge device (node) and M2 on the UE.

In example (d), M0 resides in the cloud and M1 on an edge device (node).

It is noted that a device (i.e. node) may run more than one subset. For example, M1 and M2 may be run on the same device.

As shown, the splitting points may vary depending on the model, the split model topology, the processing capability of each component (UE, Edge, Cloud device) acting in the split model topology, and fluctuating live network conditions for transmitting AI/ML data. The variety of topologies and the heterogeneity of the involved devices can raise a number of requirements and questions such as:
For a UE to determine a split model and the devices involved, it should know what AI/ML models are available for its device characteristics and how the model can be broken down. For example, what are the possible split points and what is required to execute a model subset of the model?
How can the UE know which servers (Edge/Cloud/Proximity) can provide a particular service, by running a particular subset of the model for the UE?
How can the UE interact with the application (Control Plane) and the Edge device to apply the chosen end-to-end split model, to setup links between the UE and local split nodes (e.g. edge, cloud and local links) and intermediate links between split nodes hidden from the UE.
How can the UE interact with the application (servers) to establish the related data paths? This can include the direct data path between the UE and local split nodes.

### Overview

According to the present principles, on a high level, a UE can select a split model topology among a plurality of split model topologies available for a given AI/ML service (e.g. application). The split model arrangement comprises a selection of split nodes running one or several model subsets with split node connections.

The UE can also request configuration of the selected split nodes and the establishment of a data transport session between selected split nodes, including the configuration of AI/ML specific metadata identification. Depending on the selected model, the data transport session between split nodes can be downlink or uplink (or both downlink and uplink).

The UE can further initiate data streaming service to split node sensing data to trigger data transport between the selected split nodes that may include AI/ML specific metadata comprising global AI/ML model flow identifiers and specific data/streams identifiers.

### Model Selection

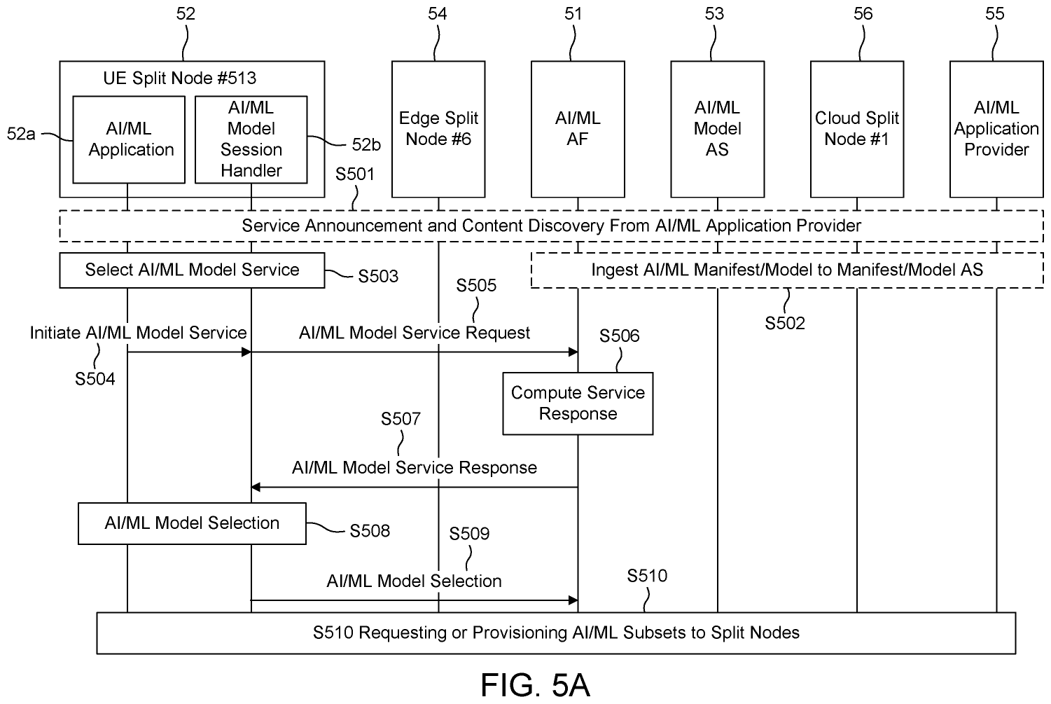

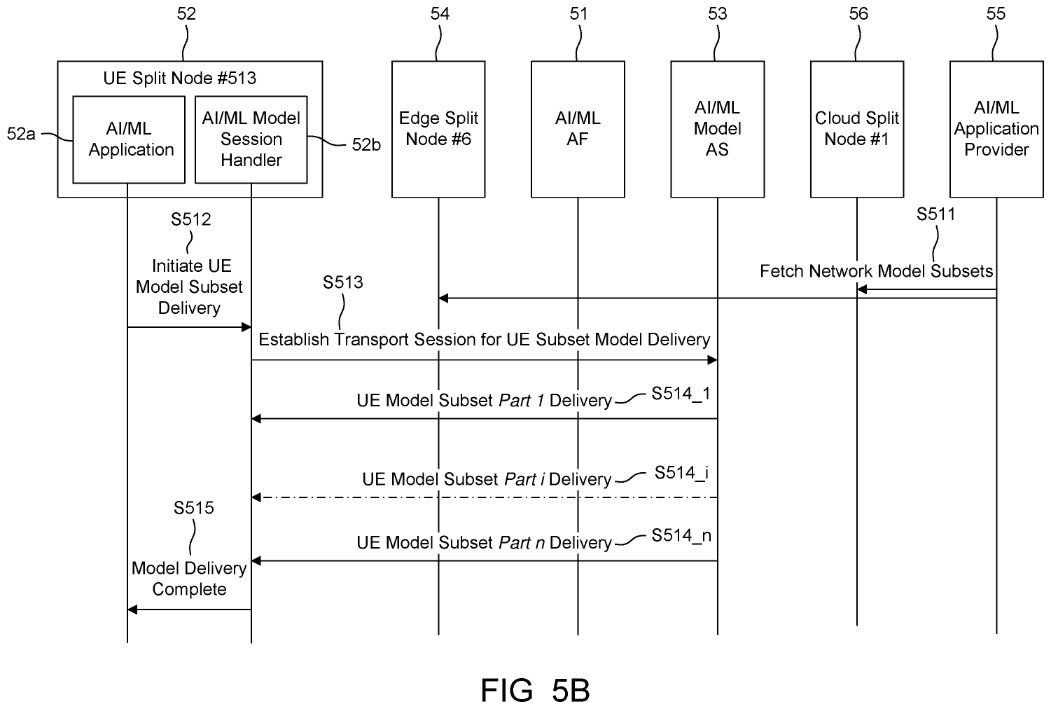

FIG. 5, made up of FIGS. 5A and 5B, illustrates an example flow chart for distributed AI/ML according to an embodiment.

FIG. 5 shows a plurality of split node candidates in a network: UE 52, an Edge device 54, and a Cloud (e.g. Access Network) device 56.

The UE 52 includes an AI/ML application 52a and an AI/ML Model Session Handler 52b. The AI/ML Model Session Handler 52b is configured to interact with an AI/ML Application Function (AF) 51 to discover and select a Model. The AI/ML application provider 55 is configured to interact with an AI/ML model Application Server (AS) 53 to provide an AI/ML model and model subsets to split nodes applications.

In step S501, the AI/ML application provider 55 sends a message related to service announcement and provisioning that indicates, for at least one AI/ML service, the alternative architecture topologies the application provider can provide to a UE, for example via the 5GS. The message can include an AI/ML service name (e.g. Split AI/ML image recognition, Enhanced media recognition, Media quality enhancement) and information about Split mode capability (i.e. an indication whether or not split mode is allowed).

In step S502, the AI/ML AF 51 and the AI/ML AS 53 interact with the AI/ML application provider 55 to ingest AI/ML Models and related AI/ML subsets that compose proposed AI/ML models. As already mentioned, an AI/ML subset is an elementary piece of software that can run independently on a UE, edge or cloud device. A UE, edge or cloud device can run one or a plurality of AI/ML subsets. For instance, a UE can host AI/ML model subset M0, M0′ or M0″, where each model subset is related to the same AI/ML model but has been generated from a different split point. The same technique extends to edge and cloud. A main condition is that subsets running on UE and/or on edge and/or on cloud are complementary.

In step S503, the UE 52 selects an AI/ML model service among those proposed by the AI/ML application provider in step S501. The UE 52 can for example select “Split AI/ML image recognition”.

In step S504, the AI/ML application 52a of the UE 52 initiates the selection of the AI/ML model service with the AI/ML Model Session Handler 52b. The selection can for example indicate one or more of the following:

Service request information including for example one or more of:
Service Name, e.g., Split AI/ML image recognition,
Service specific information e.g., requested resolution scale for enhanced media recognition service, and animal to recognize for object recognition service,
Service quality e.g., requested accuracy or precision,
Service requirements including for example:
   End-to end inference maximum expected latency, e.g., max expected latency result: 20 ms,
   UE assigned specific tasks, e.g., tasks to be performed by the UE, such as privacy preserving service tasks or delay-sensitive service tasks.

Model request information including for example one or more of:
model type,
model identifier,
identified model parts self-assigned to the UE; the UE may know the model breakdown structure and may transmit to the network an indication of model parts to be processed locally, e.g., regarding the service requirements for UE specific tasks:
   UE minimal starting model part until a defined and known split point,
   UE ending model part starting from a known split point,
identified model parts assigned to the network; the UE may know the model breakdown structure and that it cannot process identified model parts, for example, computation intensive parts:
   Network minimal starting model part until a defined and known split point,
   Network minimal ending model part starting from a known split point.

UE AI/ML engine, i.e. the engine used to run AI/ML applications including the engine version.

UE profile, for example including its OS and UE capabilities including maximum allocation, availability, average, ability for example:
Available memory allocated for the AI/ML service,
Processing capabilities available for the UE inference (CPU/GPU/TPU/NPU),
Maximum available energy consumption,
Computing performance ability (e.g. floating-point operations per second, aka flops).

Network capabilities including for example available bandwidth between UE and the network nodes (RAN/Edge/Cloud/Application servers/Core network nodes).

Distribution configurations (preferred or available), for example:
Delivery mode including progressive download, DASH streaming or Real Time transport (e.g., RTP),
Distribution mode on the device, such as Unicast/Multicast/Broadcast.

Split mode UE support, indicating whether the UE supports AI/ML subset inference.

Split mode service support type: Edge, Cloud, or Edge and Cloud.

Sensing data estimated bandwidth (in case of UE source, as in FIG. 3).

In step S505, the AI/ML Model Session Handler 52b sends an AI/ML model service request to the AI/ML AF 51 including information received from the AI/ML application 52a in step S504.

In step S506, the AI/ML AF 51 computes an AI/ML Model service response based on at least the information received in step S505. The information, which also can include further information, can for example also include capabilities of the split node (e.g. for at least one of the edge device and the cloud device, depending on the configuration) and network conditions. The network selects a set of adapted models for the UE. If a model is not available, the network may build or ingest a new model.

Information to include in the response can include one or more of: service description, split composition alternatives, and conditions when inferring an AI/ML subset on a specific split node. Each of these will now be described.

### Service Description

The service description can be a model identifier assigned by the AI/ML AF 51 directly or on behalf of the AI/ML application provider 55.

### Split Composition Alternatives

These include different AI/ML model alternatives corresponding to the request. It can list the subset combinations, including the different split nodes of the different alternatives. Continuing the example illustrated in FIG. 2, the models can be M, M′, M″:

| Model identifier | Model subsets |
|---|---|
| M | {M0, M1, M2} |
| M′ | {M0′, M1′, M2′} |
| M″ | {M0″, M1″, M2″, M3″} |

Split composition alternatives can also include the capabilities of different split node of running AI/ML model subsets. For example, the split nodes can serve model subsets from different models M, M′, M″ as follows:

| Split node | (Model identifier: related Model | |
|---|---|---|
| identifier | subsets identifier) | Entity |
| #504 | {(M: M0); (M′: M0′); (M″: M0″)} | UE Split node, ID |
| | | #504 |
| #1 | {(M: M2); (M′: M2′, M3′); (M″: | Cloud/AS Server Split |
| | M3″)} | node, ID#1 |
| #6 | {(M: M0, M1, M2); (M′: M2, M2′); | Edge/AS server, ID #6 |
| | (M″: M1″, M2″, M3″)} | |

Split composition alternatives can also include the AI/ML model subsets that a split node is currently serving. This means that there is no need for prior provisioning for these subsets:

| Split node | Model subsets | |
|---|---|---|
| identifier | currently serving | Entity |
| #1 | {M3, M3′) | Cloud/AS Server split node #1 |
| #6 | {M2) | Edge/AS server #6 |

Split composition alternatives can also include model subset information. This information can include information about the model, such as for example direction (uplink/downlink), size, and bandwidth. The information can also include network information to download, such as for example link and network addresses

### Conditions when Inferring an AI/ML Subset on Specific Split Node

For each candidate selection pair (split node, AI/ML subset), conditions may comprise one or more of the following (with example unit of measurement within parenthesis):
Output data bandwidth (Mb/s): Bandwidth required to transmit output AI/ML data, depending on the chosen topology it may be Uplink or Downlink (or both).
Inference latency (ms): Latency from receiving input AI/ML data to serving output AI/ML data.

Inference setup time (ms): This may indicate the average time to download, possibly to compile to an AI/ML engine, to load in the memory, and to run the inference. When a split node is already running an AI/ML subset as above, the setup may be immediate as it can be enough to do it once.

Energy consumption (mJ): This may indicate a quantitative estimation of the energy

required to run the inference. This can be particularly interesting for a UE to anticipate battery drain.

TABLE 1
Example required conditions

| | Output | | | | | |
|---|---|---|---|---|---|---|
| (Split node | Data | | Inference | Inference | Energy | Computing |
| ID, | Bandwidth | | Latency | setup | consumption | performance (M |
| Subset ID) | (Mb/s) | Direction | (ms) | time (ms) | (mJ) | flops) |
| Model M | | | | | | |
| UE | 2.0 | uplink | 40 | 2000 | 200 | 500 |
| #504, M: M0 | | | | | | |
| UE | 4.0 | uplink | 30 | 4000 | 400 | 400 |
| #504, M: M1 | | | | | | |
| Edge | 4.0 | uplink | 10 | 400 | 50 | 100 |
| #6, M: M0 | | | | | | |
| Edge | 4.0 | uplink | 10 | 400 | 50 | 100 |
| #6, M: M1 | | | | | | |
| Cloud | 4.0 | uplink | 20 | 500 | 50 | 100 |
| #1, M: M1 | | | | | | |
| Cloud | 4.0 | uplink | 20 | 500 | 50 | 100 |
| #1, M: M2 | | | | | | |
| Model M′ | | | | | | |
| . . . | | | | | | |

Distribution configurations for model or model subsets including for example for each distribution mean as follows:
Delivery mode, such as progressive download or DASH streaming, Real Time transport (e.g., RTP),
Application server(s) information, such as information to connect the server to get the UE model subset.
Distribution mode, such as Unicast/Multicast/Broadcast

Following Table 1 depicts example conditions required for running a given AI/ML subset on a target split node for a selected service including e.g. composition of either M, M′ and M″.

In step S507, the AI/ML AF 51 sends the computed response to the AI/ML model session handler 52b.

In step S508, the UE 52 processes the information from the AI/ML AF and selects (chooses) a split model with a particular decomposition. The selection can be based on its own environment conditions (e.g. bandwidth, latency requirements, energy requirements, and/or security/privacy considerations). For example, the UE 52 can select Model M (M0, M1, M2) such that UE Split node #504 will infer M0 subset, Edge Split node #6 will infer M1 and Cloud Split node #1 will infer M2. Beside selecting a split decomposition/configuration candidate, the UE may also select a corresponding distribution configuration for the UE model subsets. In other words, in the example, the following is selected:

| Model M | | | | | |
|---|---|---|---|---|---|
| UE #504, M: M0 | 2.0 | uplink | 40 | 2000 | 200 |
| Edge #6, M: M1 | 4.0 | uplink | 10 | 400 | 50 |
| Cloud #1, M: M2 | 4.0 | uplink | 20 | 500 | 50 |

As an example, assume that the UE selected to run M0 on the UE locally owing to, for example, for security or privacy reasons. Without these reasons, the UE could instead have selected to run the M0 inference on the edge server #6 to optimize performance criteria.

In step S509, the AI/ML model session handler 52b transmits the selected composition to the AI/ML AF 51.

In step S510, the AI/ML AF 51 triggers the AI/ML Model AS 53 to provision the selected AI/ML model subsets to each target split point server.

The AF notifies the model selection to the AI/ML application provider that, in step S511, instructs the edge split node 54 and the cloud split node 56 to fetch network AI/ML model subsets.

In step S512, the UE 52 initiates the model delivery through the AI/ML model session handler 52a that, in step S513, establishes one or more transport sessions with the AI/ML model AS 53 that, in step S514, transmits the UE model subsets, which may be divided into multiple parts (respectively transmitted in steps S514_1 . . . S514_i . . . S514n), towards the UE split node 52.

In step S515, the AI/ML model session handler 52b notifies the AI/ML application 52a about the completion of the delivery.

Continuing the example, M0 is provided to the UE 52, M1 to the edge device 54 and M2 to the cloud device 56. It is noted that M0 can be provided to the UE at an earlier point, for example by providing the links for downloading the subsets, for instance in the response sent in step S507.

In an embodiment, the UE 52 may request establishment of a transport session to download or stream the relevant AI/ML subset e.g. M0.

In another embodiment, the AI/ML AF 51 may provide UE identification, UE authorization and other features to the AS 53.

In a further embodiment, in step S506, the AI/ML AF 51 computes a response for the UE according to a list of criteria ordered for example by latency, energy or bandwidth. An example of such a list is:

```
Low latency, low energy, UE BW=1Mbps
  Default #0: {#504:M0, #6:M1, #1M2},
  Alternative #1: {#6:M0, #6:M1, #1M2},
Low latency, low energy, BW=8Mbps
  Default #0: {#<x>:M0, #<y>:M1, #<z>M2},
  Alternative #1: {#<u>:M0, #<v>:M1, #<w>M2},
High latency, low energy, BW=15Mbps
  Default #0: {#<x>:M0, #<y>:M1, #<z>M2},
  Alternative #1: {#<u>:M0, #<v>:M1, #<w>M2},
Low latency, medium energy, BW=4Mbps
  Default #0: {#<x>:M0, #<y>:M1, #<z>M2},
  Alternative #1: {#<u>:M0, #<v>:M1, #<w>M2},
Low latency, medium energy, BW=12Mbps
  Default #0: {#<x>:M0, #<y>:M1, #<z>M2},
  Alternative #1: {#<u>:M0, #<v>:M1, #<w>M2},
Medium latency, medium energy, BW=4Mbps
  Default #0: {#<x>:M0, #<y>:M1, #<z>M2},
  Alternative #1: {#<u>:M0, #<v>:M1, #<w>M2},
Medium latency, medium energy, BW=20Mbps
  Default #0: {#<x>:M0, #<y>:M1, #<z>M2},
  Alternative #1: {#<u>:M0, #<v>:M1, #<w>M2},
High latency, medium energy, BW=0.5Mbps
  Default #0: {#<x>:M0, #<y>:M1, #<z>M2},
  Alternative #1: {#<u>:M0, #<v>:M1, #<w>M2},
...
```

In this embodiment, in step S508, the UE interprets the received information with respect to its own environment conditions (e.g. bandwidth, latency requirements, energy requirements) and selects a suitable choice, e.g. the formula that provides the best match to its conditions.

In yet another embodiment, the service announcement step S501 can indicate which optimized criteria a UE may select (e.g. latency, energy, bandwidth). The AI/ML application may be configured with a preferred criteria so that the UE preselects its best criteria when requesting model to the AI/ML AF in steps S504, S505.

### Split Node Configuration and Session Establishment

### Embodiment with Service Provider Source

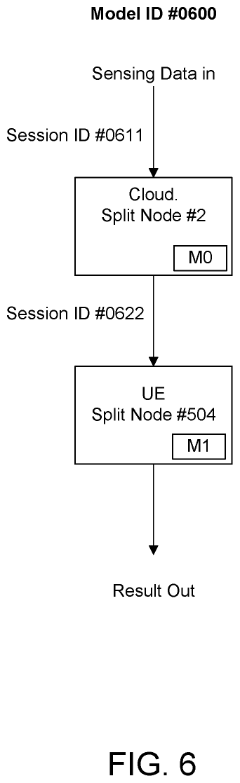

FIG. 6 illustrates an example of split node configuration. In this example, the AF has requested the running of AI/ML subset M0 in the cloud, split node #2, and subset M1 on the UE, split node #504. The AF has further requested establishment of two data transport sessions. A first session, session ID #0611, is established to enable data ingest (e.g. from the AI/ML application provider or another source) to the Cloud Application Server (AS). A second session, session ID #0622, is a downlink data session from the cloud to the UE to carry AI/ML data, i.e. data output from M0 to be used as input by M1. It is noted that the example uses a cloud split node (cf. FIG. 4 (b)), but it will be understood that an edge split node could also be used, as an alternative (cf. FIG. 4 (a)) or in addition (cf. FIG. 4 (c)).

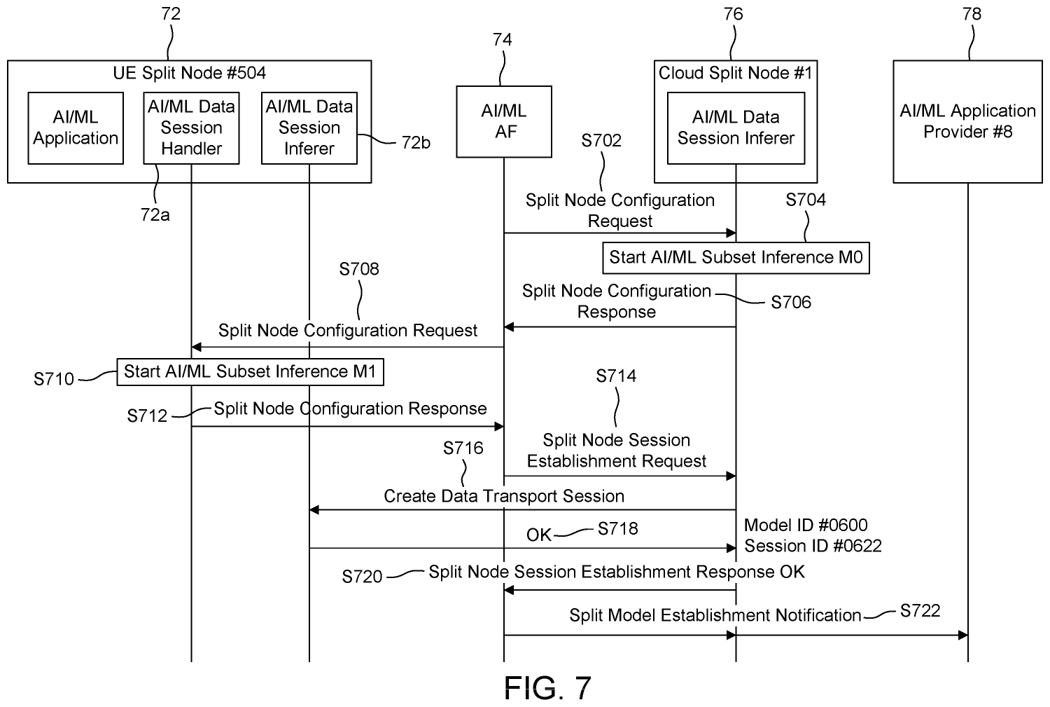

FIG. 7 illustrates a flow chart for split node configuration and data session establishment according to an embodiment.

In step S702, the AI/ML AF 74 sends a split node configuration request to a first selected split node, in the example cloud split node #1. The request includes information for configuring and running the selected and provisioned AI/ML subset M0, for example information for establishing a data session and metadata identifiers for identifying data types (sensing data, AI/ML data, result data), and model identifiers.

In step S704, the cloud split node 76 configures and runs the provisioned AI/ML subset, in the example M0.

In step S706, the cloud split node 76 sends a split node configuration response to the AI/ML AF 74 to notify completion of the request.

Steps S708-S712 are similar to steps S702-S706 but for the UE split node.

In step S708, the AI/ML AF 74 sends a split node configuration request to a second selected split node, in the example the AI/ML data session handler 72a of UE split node #504. The request includes information for configuring and running the selected and provisioned AI/ML subset M1, for example information for establishing a data session and metadata identifiers for identifying data types (sensing data, AI/ML data, result data), and model identifiers.

In step S710, the UE split node 72 configures and runs the provisioned AI/ML subset, in the example M1.

In step S712, the AI/ML data session handler 72a sends a split node configuration response to the AI/ML AF 74 to notify completion of the request.

At this point, the AI/ML AF 74 has received notifications of successful configuration notification from the involved split nodes.

An example of configuration information is found in the following table:

| Cloud/Edge split node configuration | UE split node configuration |
|---|---|
| Current Split node ID: #2 | Current Split node ID: #504 |
| Model instance ID: from step S702 | Model instance ID: from step S708 |
| Model subset: M0 | Model subset: M1 |
| Src point: #1 Cloud node | Src point: #1 Cloud node |
| Dest Point: #504 UE node | Dest Point: #0 Internal |
| Data Src Type: Sensing data | Data Src Type: AI/ML data |
| Data Dest Type: AI/ML data | Data Dest Type: Result |
| // metadata for data path | // metadata for data path |
| Data direction: Downlink | Data direction: Uplink |
| Model ID: #0600 | Model ID: #0600 |
| Src session ID: #0611 | Src session ID: #0622 |
| Dst session ID: #0622 | Dst session ID: #None |

In step S714, the AI/ML AF 74 sends a split node session establishment request to establish a transport session between the cloud split node 76, as source split node, and the UE 72, as target split node. As will be understood, a source split node provides data to a target split node.

In an alternative embodiment, the AI/ML AF 74 sends the split node session establishment request to the target split node instead of the source split node. In a further alternative, the AI/ML AF 74 sends the split node session establishment request to both the target split node and the source split node, for example to ensure secure identification and registration of peer split nodes.

In step S716, the source split node creates a data/streaming session with the target split node according to the split configuration received step S702. In the example, there is one transport session, the downlink Cloud-UE session for AI/ML data (session ID #0622; see FIG. 6).

In step S718, the target split node sends a message to acknowledge success of the data session establishment to the source split node.

In step S720, upon reception of the “success message,” the source split node sends back a split node session establishment response to the AI/ML AF 74 to signal successful session establishment.

In step S722, after receiving the successful establishment notification, the AI/ML AF 74 sends a split model establishment notification to the source split node that sensing data can be received. This notification triggers the AI/ML application provider (or other source) to start sensing data.

It is noted that this method can easily be extended to include further devices, for example if M0, M1 and M2 are inferred on different devices. It will be understood that a device, e.g. the device with M1, can be both a source and a target, receiving AI/ML data from one and sending AI/ML data to another.

### Embodiment with UE Source

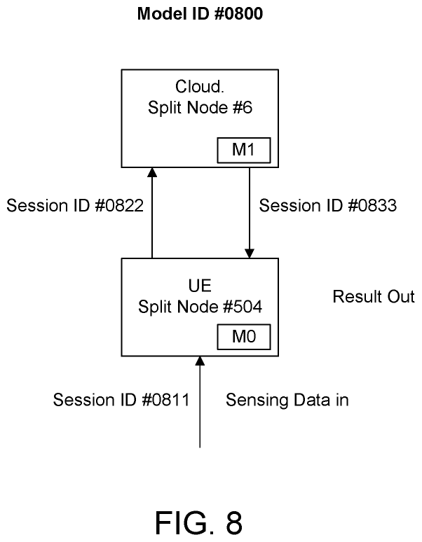

FIG. 8 illustrates a further example of split node configuration. In this example, the AF has requested the running of AI/ML subset M0 on the UE, split node #504, and subset M1 in the cloud, split node #6. The AF has further requested establishment of three data transport sessions. A first session, session ID #0811, is established to enable data ingest from the UE, for example from a camera. A second session, session ID #0822, is an uplink data session from the UE to the cloud split node to carry AI/ML data, i.e. data output from M0 to be used as input by M1. A third session, session ID #0833, is a downlink data session from the cloud split device to the UE. It is noted that the example uses a cloud split node (cf. FIG. 3 (b)), but it will be understood that an edge split node could also be used, as an alternative (cf. FIG. 3 (a)) or in addition (cf. FIG. 3 (d)).

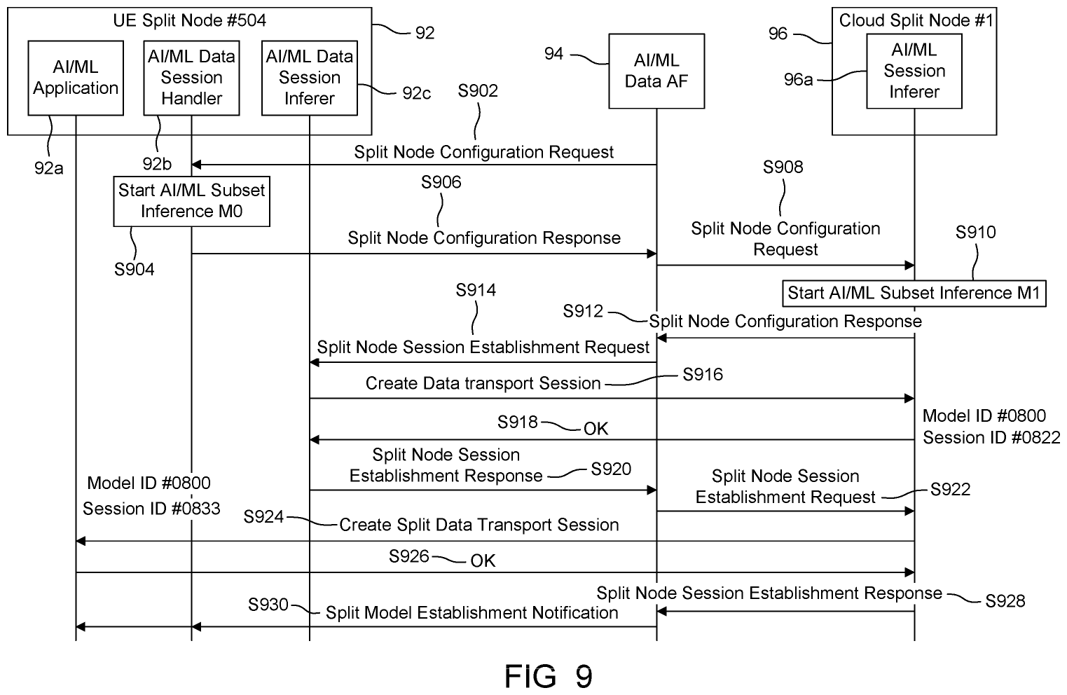

FIG. 9 illustrates a flow chart for split node configuration and session establishment according to a further embodiment.

In steps S902 and S910, the AI/ML AF 94 sends split node configuration requests to, respectively, the AI/ML data session handler 92b in the UE 92 and the AI/ML data session inferer 96a in cloud split node #1. It will be understood that the steps are similar to steps S708 and S702 in FIG. 7. Herein, ‘inferer’ is the entity (e.g. processor) that performs inference, i.e. uses at least one AI/ML subset to process sensing data or intermediate data to perform AI/ML processing to obtain intermediate data or a result.

An example of configuration information is found in the following table:

| UE split node configuration | Cloud split node configuration |
|---|---|
| Current Split node ID: #504 | Current Split node ID: #1 |
| Model instance ID: from step S902 | Model instance ID: from step S908 |
| Model subset: M0 | Model subset: M1 |
| Src point: #504 UE Inferer | Src point: #1 Cloud AS |
| Dest Point: #1 Cloud node | Dest Point: #504 UE Application |
| Data Src Type: Sensing | Data Src Type: AI/ML data |
| Data Dest Type: AI/ML data | Data Dest Type: Result |
| // metadata for data path | // metadata for data path |
| Data direction: Uplink | Data direction: Downlink |
| Model ID: #0800 | Model ID: #0800 |
| Src session ID: #0811 | Src session ID: #0822 |
| Dst session ID: #0822 | Dst session ID: #0833 |

In steps S904 and S910, the split nodes, UE 92 and cloud split node 96, respectively configure and run the provisioned AI/ML subset (M1 for cloud AS, M0 for UE).

In steps S906 and S912, the split nodes respectively send a split node configuration response to the AI/ML AF 94 to notify completion of the request.

As can be seen, steps S902-S912 are similar to steps S702-S712 in FIG. 7. At this point, the AI/ML AF 94 has received notifications of successful configuration notification from the involved split nodes.

In steps S914 and S922, the AI/ML AF 94 sends split node session establishment requests to, respectively, the AI/ML data session inferer 92c in the UE 92 and the AI/ML data inferer 96a in the cloud split server 96 to establish a transport session between the source split node, in the UE, and the target split node, in the cloud split node. In this example, the requests are sent to the source split node, i.e. sending data, to create the transport data session to its target split node. As described with reference to FIG. 7, a request can be sent to both the source split node and the target split node.

In steps S916 and S924, source split nodes create data transport sessions with its corresponding target split node according to the split configuration received in steps S902 and S908, respectively. For this embodiment, according to FIG. 8, there are three transport sessions established namely the uplink UE Streamer-Cloud for carrying AI/ML data (session ID #0822) and a downlink Cloud-UE Player for the result data (session ID #0833). The Data session ID for the running model is ID #0800.

In steps S918 and S926, the target split nodes respectively acknowledge the success of the data session establishment to the source split node.

In steps S920 and S928, in response to a “success message” (in steps S918 and S926, respectively), the source split nodes respectively send split node session establishment responses to the AI/ML AF 94.

In step S930, upon reception of the “success messages”, the AI/ML AF 94 sends a Split Model establishment notification to the source split node sensing data 92a, i.e. the AI/ML application in the UE in this example. The notification triggers the AI/ML application 92a to start sensing and providing data.

### Split Node Configuration and Session Establishment with Edge Device

### Embodiment with UE Source

This embodiment corresponds to the one illustrated in FIG. 3 (d).

In this example, the AF has requested running of AI/ML subset M0 on the UE, MI on the edge device and M2 in the cloud. The AI/ML AF has further requested establishment of four data transport sessions. The first session, #1011, is for data ingest from the UE. The second, #1022, is an uplink data session from UE to the edge device to carry AI/ML data. The third, #1033, is an uplink data session from the edge device to the cloud to carry AI/ML data. The fourth, #1044, is a downlink data session from the cloud AS to the UE to carry the result.

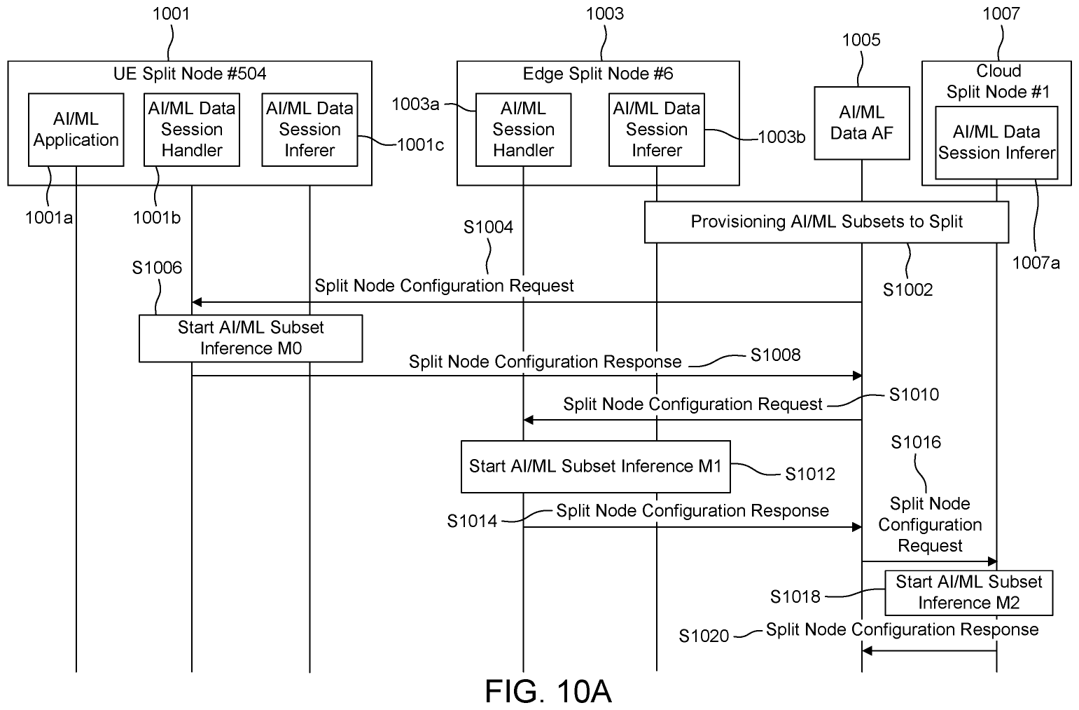

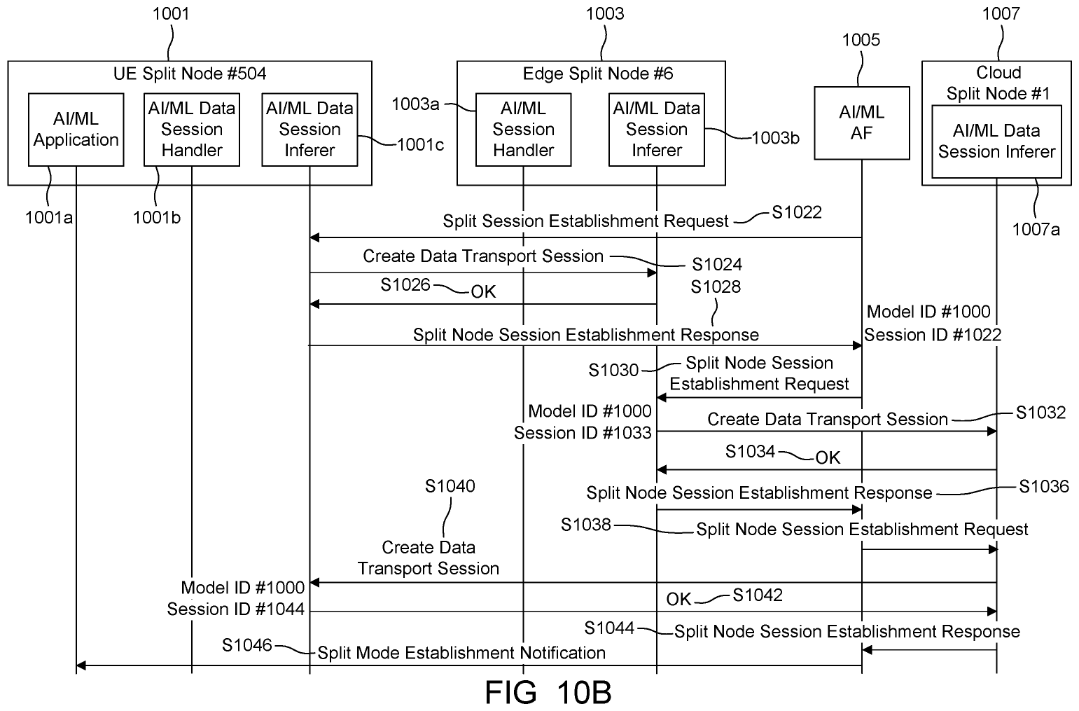

FIG. 10, made up of FIGS. 10A and 10B, illustrates a flow chart for split node configuration and session establishment according to a further embodiment.

In step S1002, AI/ML subsets are provisioned by the AI/ML model AS to the target split nodes.

In steps S1004-S1008, respectively, the AI/ML AF 1005 sends a split node configuration request to the AI/ML data session handler 1001b in the UE 1001, the AI/ML data session handler 1001b starts AI/ML subset inference M0, and sends a split node configuration response to the AI/ML AF 1005.

The request provides information for configuring and running the provisioned AI/ML subset. The information can be used for establishing a transport data session, see e.g. step S1022, including metadata identifiers for identifying data such data type (sensing data, AI/ML data, result data), data sessions (a global and common data identifier for the whole path M0, M1, M2 defining the Model instance in use, particular session data session identifiers.

Steps S1004-S1008 are similar to steps S902-S906 in FIG. 9.

Steps S1010-S1014 are essentially the same, differences including that they include the edge split node 1003 and subset M1.

In a similar way, steps S1016-S1020 are essentially the same, differences including that they include the cloud split node 1005 and subset M2.

An example of configuration information is found in the following table:

| UE split node | Edge split node | Cloud split node |
|---|---|---|
| configuration | configuration | configuration |
| Current split node ID: | Current split node ID: | Current split node ID: |
| #504 | #6 | #1 |
| Model inst. ID: | Model inst. ID: | Model inst. ID: |
| from S1002 | from S1008 | from S1016 |
| Model subset: M0 | Model subset: M1 | Model subset: M2 |
| Src point: | Src point: | Src point: |
| #504 UE node | #6 Edge node | #1 Cloud node |
| Dest point: | Dest point: | Dest point: |
| #6 Edge node | #1 Cloud node | #504 UE node |
| Data Src Type: | Data Src Type: | Data Src Type: |
| Sensing | AI/ML data | AI/ML data |
| Data Dest Type: | Data Dest Type: | Data Dest Type: |
| AI/ML data | AI/ML data | Result data |
| // metadata for data | // metadata for data | // metadata for data |
| path | path | path |
| Data direction: Uplink | Data direction: Uplink | Data direction: Downlink |
| Model ID: #1000 | Model ID: #1000 | Model ID: #1000 |
| Src session ID: #1011 | Src session ID: #1022 | Src session ID: #1033 |
| Dst session ID: #1022 | Dst session ID: #1033 | Dst session ID: #1044 |

At this point, if everything has gone well, the AI/ML AF 1005 has received successful configuration notifications from the three split nodes.

In steps S1022, S1030 and S1038, the AI/ML AF sends split node session establishment request to, respectively, AI/ML data session inferers 1001c, 1003b and 1007a, to establish a transport session between the respective source split node and the target split node. In this embodiment, the request is sent to the respective source split device, i.e. sending data, in charge of creating the transport data session to the next split device. As already described, the request can be sent to both the source split device and the target split device.

In the embodiment, the AI/ML AF plays a central role. In other embodiments, “direct mode”, a source split node, e.g. the UE, sends a split node session establishment request directly to the target split node before notifying the AI/ML AF. In another embodiment, “recursive mode”, a source split node sends a split node session establishment request to its target split node that in turn, acting as a source split node, sends a further split node session establishment request to its target split node until the end.

In steps S1024, S1032 and S1040, the respective source split nodes create a data transport session with their respective target split nodes according to the received split configuration. In the example, three transport sessions are established:
Uplink UE to Edge for first AI/ML data (session ID #1022).
Uplink Edge to Cloud for second AI/ML data (session ID #1033)
Downlink Cloud to UE Player for result data (session ID #1044).

In steps S1026, S1034 and S1042, the respective target split nodes send messages indicating success of the data session establishment to the corresponding source split device.

In steps S1028, S1036 and S1044, upon reception of the message indicating success, the source split devices respectively send a split device session establishment response to the AI/ML AF 1005.

In step S1046, after receiving successful establishment notifications, the AI/ML AF 1005 sends a Split Model establishment notification to the source server sensing data, i.e. the UE in the example. The notification triggers the AI/ML application to start sensing data.

### AI/ML Data Transport Including AI/ML Metadata

AI/ML specific metadata identifiers can for example include one or more of:
Model flow identifier: identifiers carried alongside all data transport session assigned to the model instance.
   Model identifier: a common identifier identifying the model within each data transport session.
   Input model rate: indicates the input sensing data rate that may evolve e.g. 50%, 100%.
Data transport session identifiers: identifiers specific to individual data transport sessions established between two split devices, for example:
   AI/ML subset source identifier
   AI/ML subset target identifier
   AI/ML data transport format, e.g. 8, 16 or 32 bits
   AI/ML data transport type, e.g.:
      sensing media data (e.g. image/video capture)
      AI/ML data, aka intermediate data (e.g. image/video latent code)
      Result data: output “readable” data and result data type, e.g.:
         Textual type (e.g. textual prediction cat vs. dog)
         Media type (e.g. enhanced processed video AR, Video overlaying), e.g.:
         Video type
         Audio type
         Other . . .
   Model rate adaptation: split device may adjust the frame rate output for resource allocation and indicate that ratio all along the flow e.g. 50%, 100%
   AI/ML data transport package, for example:
      Compressed data indicator
      Compression algorithm indication

It is noted that result data can originate from a possible early/intermediate exit of an AI/ML model. Such result data can feed another AI/ML subset, thus brought to a split node, as well.

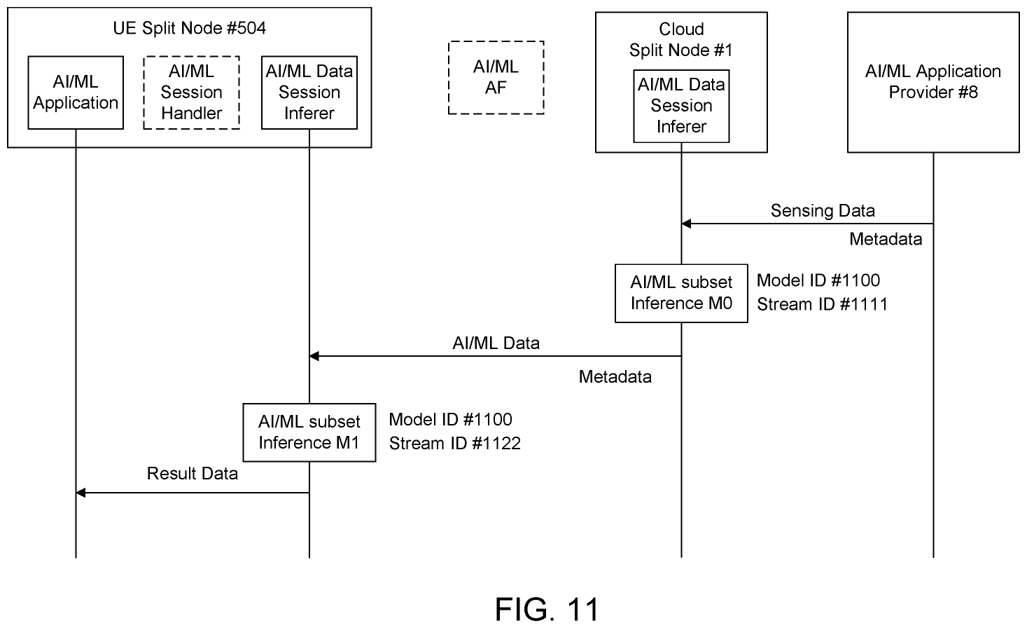

FIG. 11 illustrates an example of data transport between AI/ML split devices. The AI/ML application provider (#8) sends sensing data to the cloud split node #1. The metadata for the transmission is: Model ID #1100, Stream ID #1111. The cloud split node uses AI/ML subset M0 to infer the received sensing data to obtain AI/ML data that is sent to the AI/ML data session inferer in UE split node #504. The metadata for the transmission is: Model ID #1100 (i.e. the same as for the previous transmission), Stream ID #1122. The UE then uses AI/ML subset M1 to obtain result data that is provided to the AI/ML application in the UE.

It is noted that while the description in places mentions the AI ML application provider as the source of the sensing data, these data can also be provided by another device.

### Conclusion

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

1. A method performed by a first device and comprising:
receiving, from a second device, information indicative of a plurality of distributed Artificial Intelligence (AI) models, wherein each model of the plurality of distributed AI models corresponds to a same AI service, and wherein a distributed AI model comprises a plurality of model subsets arranged so that output of processing of one model subset on one device provides input for a following model subset on another device;
transmitting, to the second device, a message including information indicative of a selected distributed AI model from among the plurality of distributed AI models;
receiving information corresponding to a model subset of the selected distributed AI model; and
running the model subset of the selected distributed AI model based on the information corresponding to the model subset.

2. The method of claim 1, comprising:
before receiving the information indicative of a plurality of distributed AI models, transmitting, to the second device, information indicative of a request for the AI service.

3-8. (canceled)

9. The method of claim 1, wherein the model subset is run using sensing data as input to obtain an intermediate result, the method comprising:
outputting the intermediate result to a third device for running of a further model subset.

10. The method of claim 9, comprising:
receiving a final result of the selected distributed AI model from a device having inferred the final result.

11. The method of claim 10, wherein:
the third device is the same as the device having inferred the final result.

12. (canceled)

13. The method of claim 9, wherein the intermediate result is provided to the third device over an established transport session, the method further comprising:
receiving metadata related to the established transport session.

14. The method of claim 9, wherein the intermediate result includes intermediate data and metadata indicative of a nature of the intermediate data.

15. The method of claim 1, wherein the model subset is run using an intermediate result as input to obtain a final result, the intermediate result obtained from a third device having inferred the intermediate result using a further model subset; the method comprising:
outputting the final result.

16. The method of claim 1, wherein the model subsets of a distributed AI model are configured for execution on at least two different devices.

17. The method of claim 16, wherein boundaries between the model subsets are defined by split points.

18. (canceled)

19. A first device comprising:
memory storing processor-executable program instructions; and
at least one hardware processor configured to execute the program instructions to:
receive, from a second device, information indicative of a plurality of distributed Artificial Intelligence (AI) models, wherein each model of the plurality of distributed AI models corresponds to a same AI service, and wherein a distributed AI model comprises a first plurality of model subsets arranged so that output of processing of one model subset on one device provides input for a following model subset on another device;
transmit to the second device, a message including information indicative of a selected distributed AI model from among the plurality of distributed AI models, wherein the selected distributed AI model includes a second plurality of model subsets making up the AI service; and
receive information corresponding to a model subset of the selected distributed AI model; and
run the model subset of the selected distributed AI model based on the information corresponding to the model subset.

20. The first device of claim 19, wherein the at least one hardware processor is further configured to:
before the receiving the information indicative of a plurality of distributed AI models, transmit, to the second device, information indicative of a request for the AI service.

21-26. (canceled)

27. The first device of claim 19, wherein the model subset is run using sensing data as input to obtain an intermediate result and wherein the at least one hardware processor is further configured to:
output the intermediate result to a third device for running of a further model subset.

28. The first device of claim 27, wherein the at least one hardware processor is further configured to:
receive a final result of the selected distributed AI model from a device having inferred the final result.

29. The first device of claim 28, wherein:
the third device is the same as the device having inferred the final result.

30. (canceled)

31. The first device of claim 27, wherein the intermediate result is provided to the third device over an established transport session and wherein the at least one hardware processor is further configured to receive metadata related to the established transport session.

32. The first device of claim 27, wherein the intermediate result includes intermediate data and metadata indicative of a nature of the intermediate data.

33. The first device of claim 19, wherein the model subset is run using an intermediate result as input to obtain a final result, the intermediate result obtained from a third device having inferred the intermediate result using a further model subset and wherein the at least one hardware processor is further configured to:
output the final result.

34. The first device of claim 19, wherein the model subsets of a distributed AI model are configured for execution on at least two different devices.

35-36. (canceled)

37. The first device of claim 19, wherein the first device is a wireless transmit/receive unit, WTRU.
